(19) United States
(12) Patent Application Publication
(10) Pub. No.: US 2024/0292172 A1
(43) Pub. Date: Aug. 29, 2024

(54) APPARATUS AND METHOD FOR RENDERING A VIRTUAL AUDIO SCENE EMPLOYING INFORMATION ON A DEFAULT ACOUSTIC ENVIRONMENT

(71) Applicant: Fraunhofer-Gesellschaft zur Förderung der angewandten Forschung e.V., München (DE)

(72) Inventors: Jürgen HERRE, Erlangen (DE); Vensan MAZMANYAN, Erlangen (DE); Alexander ADAMI, Erlangen (DE); Nils PETERS, Erlangen (DE); Simon SCHWÄR, Erlangen (DE); Kahleel Porter HASSAN, Erlangen (DE); Matthias GEIER, Erlangen (DE); Sujeet MATE, Tampere (FI); Antti ERONEN, Tampere (FI); Otto HARJU, Tampere (FI)

(73) Assignee: Fraunhofer-Gesellschaft zur Förderung der angewandten Forschung e.V., München (DE)

(21) Appl. No.: 18/659,897

(22) Filed: May 9, 2024

Related U.S. Application Data
(63) Continuation of application No. PCT/EP2022/081326, filed on Nov. 9, 2022.

(30) Foreign Application Priority Data
Nov. 9, 2021 (EP) 21207220.1

(51) Int. Cl. H04S 7/00

(52) U.S. Cl. CPC H04S 7/302; H04S 2420/03

(57) ABSTRACT

An apparatus for rendering a virtual audio scene according to an embodiment is provided. One or more sound sources are emitting sound in the virtual audio scene. The apparatus has an input interface configured for receiving audio information, wherein the audio information has audio information for the virtual audio scene. Moreover, the apparatus has a renderer configured for generating, depending on the audio information for the virtual audio scene, one or more audio output channels for reproducing the virtual audio scene. If information on a current acoustic environment of the virtual audio scene is not available for the renderer, the renderer is configured to generate the one or more audio output channels for reproducing the virtual audio scene depending on information on a default acoustic environment.

### CROSS-REFERENCE TO RELATED APPLICATIONS

This application is a continuation of co-pending International Application No. PCT/EP2022/081326, filed Nov. 9, 2022, which is incorporated herein by reference in its entirety, and additionally claims priority from European Application No. 21207220.1, filed Nov. 9, 2021, which is also incorporated herein by reference in its entirety.

### TECHNICAL FIELD

The present disclosure relates to employing a default acoustic environment for rendering a virtual audio scene. Moreover, the present disclosure relates to providing information a default acoustic environment. In particular, the present disclosure aims to provide improved perceived plausibility of simulated acoustic environments in case they do not contain detailed description of all acoustic properties or in case that the rendering system lacks the resources entailed to render them sufficiently. The concept is described within a binaural reproduction system, but can be extended to other forms of audio reproduction.

### BACKGROUND

The main aspect of simulated experiences like virtual reality (VR) or augmented reality (AR) is the ability to create physical spaces and environments in which a subject could perceive complex acoustical phenomena. This is especially the case in the so-called ‘six degrees of freedom’ (6DoF) simulations, in which a subject can move freely inside a room with certain physical properties and thus experience variety of acoustical interactions. Those consist of early reflections part (ER) and late reverberation part (LR). Description of the LR part of room acoustics for VR/AR scenes has been published in [1] and is called Acoustic Environment (AE).

When rendering a virtual acoustic space, a plausible rendering of late reverb is essential. Consequently, the characteristics of the late reverb can be described as a set of parameters that can control the artificial reverb generator to produce late reverb with the desired properties.

As an example, the MPEG Audio standardization group has recently published a specification for describing virtual acoustic scenes in 6 Degrees of Freedom (6DoF) that is called “Encoder Input Format” (EIF) for the MPEG-I Audio 6DoF standardization [1] and may, for example, be expressed in XML. Among many other relevant constructs in this EIF specification (e.g. the specification of audio sources of different kind, like object sources, channel sources and Higher Order Ambisonics sources), it also contains a so-called Acoustic Environment description that characterizes the late reverb characteristics of a specified acoustic space.

To this end, it may, e.g., contains fields/parameters describing, for example, the geometric region to which these parameters apply (“region”) or the region within which the specified parameters in the EIF are considered valid; a spatial point where the indicated parameters have been measured (“position”); an initial time delay after which the late reverb starts (“predelay”); a set of frequencies (“frequency”) with associated RT60 values (i.e. the time it takes until the late reverb has decayed by 60 dB) and a Diffuse-to-Direct Ratio (“DDR”) describing the ratio between the diffuse late reverb energy and the direct/emitted sound energy, i.e. the reverb amplitude/level.

This information may, e.g., be employed for a realistic rendering of the late reverb in a virtual auditory environment.

When rendering VR/AR scenes, acoustic parameters for rendering of room acoustics are usually supplied. Sometimes, however, no acoustic parameters have been specified during the scene authoring process, e.g., for outdoor scene parts, or scene parts with partial opening to the outdoor, etc. . . . . This will result in an unsatisfactory unnaturally rendering because without acoustic parameters sound sources are practically rendered almost like in an anechoic room, because of missing signal components related to reflections, reverberation or background noise.

The object of the present disclosure is to provide improved concepts for avoiding unfavorable rendering behavior.

### SUMMARY

According to an embodiment, an apparatus for rendering a virtual audio scene, may have: an input interface configured for receiving audio information, wherein the audio information has audio information for the virtual audio scene, and a renderer configured for generating, depending on the audio information for the virtual audio scene, one or more audio output channels for reproducing the virtual audio scene, wherein, upon determining that information on a current acoustic environment of the virtual audio scene is unavailable for the renderer, the renderer is configured to generate the one or more audio output channels for reproducing the virtual audio scene depending on information on a default acoustic environment.

According to another embodiment, a bitstream may have: an encoding of one or more audio channels of each sound source of one or more sound sources emitting sound into a virtual audio scene, and a plurality of data fields having information on a default acoustic environment.

Another embodiment may have an encoder, configured for generating a bitstream, wherein the encoder is configured to generate the bitstream such that the bitstream has an encoding of one or more audio channels of each sound source of one or more sound sources emitting sound into a virtual audio scene, and wherein the encoder is configured to generate the bitstream such that the bitstream has a plurality of data fields having information on a default acoustic environment.

According to another embodiment, a method for rendering a virtual audio scene, may have the steps of: receiving audio information, wherein the audio information has audio information for the virtual audio scene, and generating, depending on the audio information for the virtual audio scene, one or more audio output channels for reproducing the virtual audio scene, wherein, upon determining that information on a current acoustic environment of the virtual audio scene is unavailable, generating the one or more audio output channels for reproducing the virtual audio scene is conducted depending on information on a default acoustic environment.

Another embodiment may have a method for generating a bitstream, wherein generating the bitstream is conducted such that the bitstream has an encoding of one or more audio channels of each sound source of one or more sound sources emitting sound into a virtual audio scene, and wherein generating the bitstream is conducted such that the bitstream such that the bitstream has a plurality of data fields having information on a default acoustic environment.

Another embodiment may have a non-transitory computer-readable medium having a computer program for implementing the above method for rendering a virtual audio scene upon being executed on a computer or signal processor. Another embodiment may have a non-transitory computer-readable medium having a computer program for implementing the above method for generating a bitstream upon being executed on a computer or signal processor.

An apparatus for rendering a virtual audio scene according to an embodiment is provided. One or more sound sources are emitting sound in the virtual audio scene. The apparatus includes an input interface configured for receiving audio information, wherein the audio information includes audio information for the virtual audio scene. Moreover, the apparatus includes a renderer configured for generating, depending on the audio information for the virtual audio scene, one or more audio output channels for reproducing the virtual audio scene. upon information on a current acoustic environment of the virtual audio scene is unavailable for the renderer, the renderer is configured to generate the one or more audio output channels for reproducing the virtual audio scene depending on information on a default acoustic environment.

Moreover, a bitstream according to an embodiment is provided. The bitstream includes an encoding of one or more audio channels of each sound source of one or more sound sources emitting sound into a virtual audio scene. Furthermore, the bitstream includes a plurality of data fields including information on a default acoustic environment.

Furthermore, an encoder, configured for generating a bitstream, according to an embodiment is provided. The encoder is configured to generate the bitstream such that the bitstream includes an encoding of one or more audio channels of each sound source of one or more sound sources emitting sound into a virtual audio scene. Moreover, the encoder is configured to generate the bitstream such that the bitstream includes a plurality of data fields including information on a default acoustic environment.

Moreover, a method for rendering a virtual audio scene according to an embodiment is provided. One or more sound sources are emitting sound in the virtual audio scene. The method includes:
Receiving audio information, wherein the audio information includes audio information for the virtual audio scene, and:
Generating, depending on the audio information for the virtual audio scene, one or more audio output channels for reproducing the virtual audio scene.

Upon determining that information on a current acoustic environment of the virtual audio scene is unavailable, generating the one or more audio output channels for reproducing the virtual audio scene is conducted depending on information on a default acoustic environment.

Furthermore, a method for generating a bitstream according to an embodiment is provided. Generating the bitstream is conducted such that the bitstream includes an encoding of one or more audio channels of each sound source of one or more sound sources emitting sound into a virtual audio scene. Moreover, generating the bitstream is conducted such that the bitstream such that the bitstream includes a plurality of data fields including information on a default acoustic environment.

Moreover, a computer program for implementing one of the above-described methods upon being executed on a computer or signal processor is provided.

### BRIEF DESCRIPTION OF THE DRAWINGS

In the following, embodiments of the present disclosure are described in more detail with reference to the figures, in which:

FIG. 1 illustrates an apparatus for rendering a virtual audio scene according to an embodiment;

FIG. 2 illustrates a bitstream according to an embodiment; and

FIG. 3 illustrates an encoder, configured for generating a bitstream, according to an embodiment.

### DETAILED DESCRIPTION

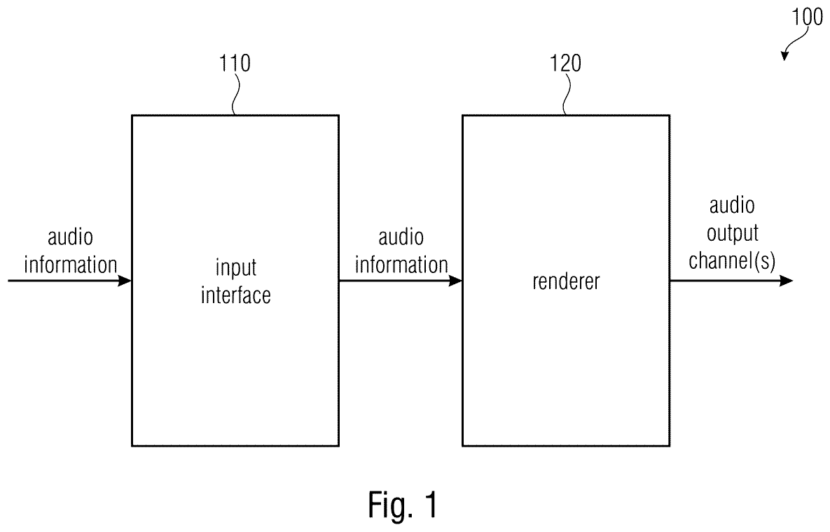

FIG. 1 illustrates an apparatus 100 for rendering a virtual audio scene according to an embodiment. One or more sound sources are emitting sound in the virtual audio scene. The apparatus 100 includes an input interface 110 configured for receiving audio information, wherein the audio information includes audio information for the virtual audio scene.

Moreover, the apparatus 100 includes a renderer 120 configured for generating, depending on the audio information for the virtual audio scene, one or more audio output channels for reproducing the virtual audio scene.

If information on a current acoustic environment of the virtual audio scene is not available for the renderer 120, the renderer 120 is configured to generate the one or more audio output channels for reproducing the virtual audio scene depending on information on a default acoustic environment.

According to an embodiment, if information on the current acoustic environment of the virtual audio scene is available for the renderer 120, the renderer 120 may, e.g., be configured to generate the one or more audio output channels for reproducing of the virtual audio scene depending on the information on the current acoustic environment of the virtual audio scene.

In an embodiment, the input interface 110 may, e.g., be configured to receive a bitstream including the audio information. If the bitstream includes information on the current acoustic environment of the virtual audio scene, the current acoustic environment of the virtual audio scene is available for the renderer 120, and the renderer 120 may, e.g., be configured to generate the one or more audio output channels for reproducing the virtual audio scene depending on the information on the current acoustic environment of the virtual audio scene being included by the bitstream. If the bitstream does not include the information on the current acoustic environment of the virtual audio scene, the current acoustic environment of the virtual audio scene is not available for the renderer 120, and the renderer 120 may, e.g., be configured to generate the one or more audio output channels for reproducing the virtual audio scene depending on the information on the default acoustic environment. According to an embodiment, the bitstream includes information on the default acoustic environment.

In an embodiment, the apparatus 100 includes a memory having stored thereon predefined information, wherein the predefined information includes the default acoustic environment. According to an embodiment, the default acoustic environment represents an outdoor acoustic environment.

In an embodiment, for each region of a plurality of regions of the virtual audio scene, for which information on a current acoustic environment for said region is available for the renderer 120, the renderer 120 may, e.g., be configured to generate the one or more audio output channels for reproducing the virtual audio scene using the information on the current acoustic environment for said region, if the listener is in said region. For each region of the plurality of regions of the virtual audio scene, for which information on the current acoustic environment for said region is not available for the renderer 120, the renderer 120 may, e.g., be configured to use the information on the default acoustic environment as information on an acoustic environment for said region to generate the one or more audio output channels for reproducing the virtual audio scene, if the listener is in said region.

According to an embodiment, if for at least one region of the plurality of regions of the virtual audio scene, information on the current acoustic environment for said at least one region is available for the renderer 120, and, if the listener is in one of said at least one regions, the renderer 120 may, e.g., be configured to use the information on the current acoustic environment for said region to generate the one or more audio output channels for reproducing the virtual audio scene. If for at least two regions of the plurality of regions of the virtual audio scene, information on the current acoustic environment for said at least two regions is not available for the renderer 120, and, if the listener is in one of said at least two regions, the renderer 120 may, e.g., be configured to use the information on the default acoustic environment as the information on the acoustic environment for said region to generate the one or more audio output channels for reproducing the virtual audio scene.

In an embodiment, the receiving interface may, e.g., be configured to receive indication data indicating those of the plurality of regions of the virtual audio scene for which the current acoustic environment is valid and/or indicating those of the plurality of regions of the virtual audio scene for which the current acoustic environment is not valid. For each region of the plurality of regions of the virtual audio scene, for which the current acoustic environment is valid, the renderer 120 may, e.g., be configured to generate the one or more audio output channels for reproducing the virtual audio scene using the information on the current acoustic environment for said region, if the listener is in said region. For each region of the plurality of regions of the virtual audio scene, for which the current acoustic environment is not valid, the renderer 120 may, e.g., be configured to use the information on the default acoustic environment as the information on the acoustic environment for said region to generate the one or more audio output channels for reproducing the virtual audio scene, if the listener is in said region.

According to an embodiment, the information on the default acoustic environment includes one or more reverberation parameters which include information on one or more properties of reverberation in the default acoustic environment. If information on the current acoustic environment for a region of the plurality of regions of the virtual audio scene is available for the renderer 120, the renderer 120 may, e.g., be configured to generate the one or more audio output channels for reproducing the virtual audio scene depending on the one or more reverberation parameters of the current acoustic environment for said region, if the listener is in said region. If information on the current acoustic environment for said region is not available for the renderer 120, the renderer 120 may, e.g., be configured to generate the one or more audio output channels for reproducing the virtual audio scene depending on the one or more reverberation parameters of the information on the default acoustic environment, if the listener is in said region.

In an embodiment, the one or more reverberation parameters of the information on the default acoustic environment include information on one or more of a pre-delay time, a reverberation time, and a reverberation amplitude.

According to an embodiment, the information on the default acoustic environment includes one or more early reflection parameters which include information on one or more properties of early reflections in the default acoustic environment. If information on the current acoustic environment for a region of the plurality of regions of the virtual audio scene is available for the renderer 120, the renderer 120 may, e.g., be configured to generate the one or more audio output channels for reproducing the virtual audio scene depending on the one or more early reflection parameters of the current acoustic environment for said region, if the listener is in said region. If information on the current acoustic environment for said region is not available for the renderer 120, the renderer 120 may, e.g., be configured to generate the one or more audio output channels for reproducing the virtual audio scene depending on the one or more early reflection parameters of the information on the default acoustic environment, if the listener is in said region.

In an embodiment, the information on the default acoustic environment includes one or more background parameters which include information one or more properties of background sound in the default acoustic environment. If information on the current acoustic environment for a region of the plurality of regions of the virtual audio scene is available for the renderer 120, the renderer 120 may, e.g., be configured to generate the one or more audio output channels for reproducing the virtual audio scene depending on the one or more background parameters of the information on the current acoustic environment for said region, if the listener is in said region. If information on the current acoustic environment for said region is not available for the renderer 120, the renderer 120 may, e.g., be configured to generate the one or more audio output channels for reproducing the virtual audio scene depending on the one or more background parameters of the information on the default acoustic environment, if the listener is in said region.

According to an embodiment, the one or more background parameters of the information on the default acoustic environment include one or more rendering parameters for the background sound, wherein said rendering parameters include information on one or more of a background sound waveform, an identifier of the background sound waveform, a background signal level and a filtering characteristic that indicates a frequency response that is to be applied on the background sound waveform.

In an embodiment, the information on the default acoustic environment includes one or more default acoustic environment steering parameters for steering a usage of the default acoustic environment by the renderer 120. If information on the current acoustic environment for a region of the plurality of regions of the virtual audio scene is available for the renderer 120, the renderer 120 may, e.g., be configured to generate the one or more audio output channels for reproducing the virtual audio scene using, depending on the default acoustic environment steering parameters, the information on the current acoustic environment for said region, if the listener is in said region. If information on the current acoustic environment for said region is not available for the renderer 120, the renderer 120 may, e.g., be configured to generate the one or more audio output channels for reproducing the virtual audio scene using, depending on the default acoustic environment steering parameters, the information on the default acoustic environment, if the listener is in said region.

According to an embodiment, the default acoustic environment includes one or more triggering conditions required to trigger one or more or all of the parameters or components of the default acoustic environment. If information on the current acoustic environment for a region of the plurality of regions of the virtual audio scene is not available for the renderer 120, the renderer 120 may, e.g., be configured to generate the one or more audio output channels for reproducing the virtual audio scene depending on the information on the default acoustic environment by triggering those parameters or components of the default acoustic environments whose at least one triggering condition of the one or more triggering conditions are fulfilled.

In an embodiment, the information on the default acoustic environment includes one or more modification parameters for modifying at least one of a gain, a distance weighting, a time delay, an occlusion weighting, a speed weighting, a spatial source saturation weighting. The renderer 120 may, e.g., be configured to generate the one or more audio output channels for reproducing the virtual audio scene depending on the one or more modification parameters.

According to an embodiment, the virtual audio scene depends on a recording of a real audio scene under a real acoustic environment.

In an embodiment, for each region of the plurality of regions of the virtual audio scene, for which information on a current acoustic environment for said region is available for the renderer 120, the current acoustic environment for said region represents the real acoustic environment of a real region of the real audio scene corresponding to said region of the virtual audio scene. For each region of the plurality of regions of the virtual audio scene, for which information on the current acoustic environment for said region is not available for the renderer 120, the default acoustic environment does not represent the real acoustic environment of the real region of the real audio scene corresponding to said region of the virtual audio scene.

According to an embodiment, the virtual audio scene is associated with a virtual visual scene, wherein the virtual visual scene depicts to the listener of the virtual audio scene a virtual visual room.

In an embodiment, for each region of the plurality of regions of the virtual audio scene, for which information on a current acoustic environment for said region is available for the renderer 120, the current acoustic environment for said region depends on virtual acoustic properties of a region of the virtual visual room, which corresponds to said region of the virtual audio scene. For each region of the plurality of regions of the virtual audio scene, for which information on the current acoustic environment for said region is not available for the renderer 120, the default acoustic environment does not depend on virtual acoustic properties of a region of the virtual visual room, which corresponds to said region of the virtual audio scene.

According to an embodiment, a location of the listener in the virtual audio scene depends on a physical location of the listener in the real world.

In an embodiment, the virtual audio scene is associated with a virtual visual presentation of an augmented reality application, wherein the virtual visual presentation of the augmented reality application depends on a real region of a physical environment in the real world, where the listener of the virtual audio scene is located.

According to an embodiment, for each region of the plurality of regions of the virtual audio scene, for which information on a current acoustic environment for said region is available for the renderer 120, the current acoustic environment for said region depends on real acoustic properties of a region of the physical environment the real world, which corresponds to said region of the virtual audio scene. For each region of the plurality of regions of the virtual audio scene, for which information on the current acoustic environment for said region is not available for the renderer 120, the default acoustic environment does not depend on acoustic properties of a region the physical environment of the real world, which corresponds to said region of the virtual audio scene.

In an embodiment, if the real region in the real world, where the listener is located, corresponds to a region of the virtual audio scene, for which information on the current acoustic environment is available, the renderer 120 may, e.g., be configured to generate the one or more audio output channels for reproducing the virtual audio scene depending on the current acoustic environment for said region. If the real region in the real world, where the listener is located, corresponds to a region of the virtual audio scene, for which information on the current acoustic environment is not available, the renderer 120 may, e.g., be configured to generate the one or more audio output channels for reproducing the virtual audio scene depending on the default acoustic environment.

According to an embodiment, the default acoustic environment is a first default acoustic environment of two or more default acoustic environments. The input interface 110 may, e.g., be configured to receive, for at least one region of the plurality of regions of the virtual audio scene, an indication indicating one of the two or more default acoustic environments as a default acoustic environment for said at least one region. If, for said at least one region, information on the current acoustic environment for said at least one region is not available for the renderer 120, the renderer 120 may, e.g., be configured to use information on the default acoustic environment for said region to generate the one or more audio output channels for reproducing the virtual audio scene, if the listener is in said region.

In an embodiment, the bitstream includes information on the two or more default acoustic environments.

According to an embodiment, the predefined information, being stored in the memory of the apparatus 100, includes information on the two or more default acoustic environments.

In an embodiment, the receiving interface may, e.g., be configured to receive selection information. The renderer 120 may, e.g., be configured to select said one of the two or more default acoustic environments depending on selection information, and may, e.g., be configured to use the information on the default acoustic environment for said at least one region to generate the one or more audio output channels for reproducing the virtual audio scene, if the listener is in said at least one region.

According to an embodiment, the indication indicating said one of the two or more default acoustic environments as the default acoustic environment for said at least one region includes an identifier for each of said at least one region and/or includes an identifier for said one of the two or more default acoustic environments.

In an embodiment, the audio information for the virtual audio scene includes one or more audio channels of each sound source of the one or more sound sources and a position of each sound source of the one or more sound sources. The renderer 120 may, e.g., be configured to generate the one or more audio output channels for reproducing the virtual audio scene depending on the one or more audio channels of each sound source of the one or more sound sources, depending on the position of each sound source of the one or more sound sources and depending on a position of a listener in the virtual audio scene.

According to an embodiment, the position of the sound source and the position of the listener are defined for three dimensions. And/or, the position of the sound source and the position of the listener are defined for two dimensions.

In an embodiment, the position of the sound source is defined for three dimensions. The listener position and orientation is defined for six-degrees-of-freedom, such that the position of the listener is defined for three dimensions, and the orientation of a head of the listener is defined using three rotation angles. The renderer 120 may, e.g., be configured to generate the one or more audio output channels for reproducing the virtual audio scene further depending on the orientation of the head of the listener in the virtual audio scene.

According to an embodiment, the sound scene generator may, e.g., be configured to reproduce the virtual audio scene of a virtual reality application. Alternatively, the sound scene generator may, e.g., be configured to reproduce the virtual audio scene of an augmented reality application.

In an embodiment, the one or more audio channels of at least one sound source of the one or more sound sources are represented in an Ambisonics Domain. The renderer 120 may, e.g., be configured to generate the one or more audio output channels for reproducing the virtual audio scene depending on the one or more audio channels of said at least one sound source of the one or more sound sources being represented in the Ambisonics Domain.

According to an embodiment, the renderer 120 includes a binauralizer configured to generate two audio output channels for reproducing the virtual audio scene.

In an embodiment, if one or more, but not all of a plurality of parameters of the current acoustic environment are available for the renderer 120, the renderer 120 may, e.g., be configured to generate the one or more audio output channels for reproducing the virtual audio scene depending on those of a plurality of parameters of the information on the default acoustic environment, which have not been provided for the current acoustic environment within the bitstream.

According to an embodiment, if information on the current acoustic environment of the virtual audio scene is available for the renderer 120, the renderer 120 may, e.g., be configured to generate the one or more audio output channels for reproducing the virtual audio scene using, depending on an availability of resources of the renderer 120 to render acoustic properties, the information on the current acoustic environment of the virtual audio scene or the information on the default acoustic environment.

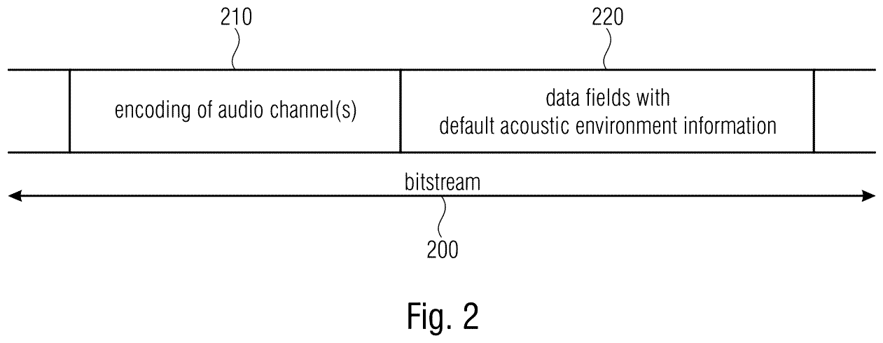

FIG. 2 illustrates a bitstream 200 according to an embodiment.

The bitstream 200 includes an encoding 210 of one or more audio channels of each sound source of one or more sound sources emitting sound into a virtual audio scene.

Furthermore, the bitstream 200 includes a plurality of data fields 220 including information on a default acoustic environment.

According to an embodiment, the information on the default acoustic environment within the bitstream 200 includes one or more reverberation parameters of the default acoustic environment which include information on one or more properties of reverberation in the default acoustic environment.

In an embodiment, the one or more reverberation parameters of the information on the default acoustic environment include information on one or more of a pre-delay time, a reverberation time, and a reverberation amplitude.

According to an embodiment, the information on the default acoustic environment within the bitstream 200 includes one or more early reflection parameters which include information on one or more properties of early reflections in the default acoustic environment.

In an embodiment, the information on the default acoustic environment within the bitstream 200 includes one or more background parameters which include information one or more properties of background sound in the default acoustic environment.

According to an embodiment, the one or more background parameters of the information on the default acoustic environment within the bitstream 200 include one or more rendering parameters for the background sound, wherein said rendering parameters include information on one or more of a background sound waveform, an identifier of the background sound waveform, a background signal level and a filtering characteristic that indicates a frequency response that is to be applied on the background sound waveform.

In an embodiment, the bitstream 200 includes one or more default acoustic environment steering parameters for steering a usage of the default acoustic environment by the renderer 120.

According to an embodiment, the default acoustic environment includes one or more triggering conditions required to trigger one or more or all of the parameters or components of the default acoustic environment.

In an embodiment, the bitstream 200 includes one or more modification parameters for modifying at least one of a gain, a distance weighting, a time delay, an occlusion weighting, a speed weighting, a spatial source saturation weighting.

According to an embodiment, the information on the default acoustic environment is first information on a first default acoustic environment of two or more default acoustic environments. The bitstream 200 includes information on the two or more default acoustic environments.

In an embodiment, the bitstream 200 includes selection information for selecting one of the two or more default acoustic environments.

According to an embodiment, the bitstream 200 specifies, for at least one region of plurality of regions, one of the two or more default acoustic environments as a default acoustic environment for said at least one region.

In an embodiment, the bitstream 200 includes an identifier for each of said at least one region and/or includes an identifier for said one of the two or more default acoustic environments to indicate the default acoustic environment for said at least one region.

According to an embodiment, the bitstream 200 further includes information on a current acoustic environment of the virtual audio scene.

In an embodiment, the bitstream 200 includes indication data indicating at least one of plurality of regions for which the current acoustic environment is valid and/or indicating one or more of the plurality of regions for which the current acoustic environment is not valid.

According to an embodiment, the bitstream 200 further includes information on a current acoustic environment for at least one region of plurality of regions of the virtual audio scene.

A further embodiment relates to the apparatus 100 of the embodiment of FIG. 1. The bitstream 200 received by the receiving interface of the apparatus 100 is a bitstream 200 according to the embodiment of FIG. 2. If the bitstream 200 does not include information on the current acoustic environment of the virtual audio scene, the renderer 120 may, e.g., be configured to generate the one or more audio output channels for reproducing the virtual audio scene depending on the information on the default acoustic environment being included by the bitstream 200, such that generating the one or more audio output channels depends on one or more of the following:
one or more reverberation parameters of the default acoustic environment which include information on one or more properties of reverberation in the default acoustic environment and/or information on one or more of a pre-delay time, a reverberation time, and a reverberation amplitude,
one or more early reflection parameters which include information on one or more properties of early reflections in the default acoustic environment,
one or more background parameters which include information one or more properties of background sound in the default acoustic environment, and/or one or more rendering parameters for the background sound, wherein said rendering parameters include information on one or more of a background sound waveform, an identifier of the background sound waveform, a background signal level and a filtering characteristic that indicates a frequency response that is to be applied on the background sound waveform,
one or more default acoustic environment steering parameters for steering a usage of the default acoustic environment by the renderer 120,
one or more triggering conditions required to trigger one or more or all of the parameters or components of the default acoustic environment.

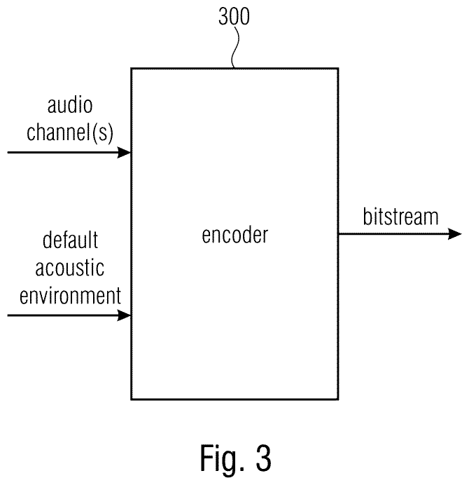

FIG. 3 illustrates an encoder 300, configured for generating a bitstream, according to an embodiment.

The encoder 300 is configured to generate the bitstream such that the bitstream includes an encoding of one or more audio channels of each sound source of one or more sound sources emitting sound into a virtual audio scene.

Moreover, the encoder 300 is configured to generate the bitstream such that the bitstream includes a plurality of data fields including information on a default acoustic environment.

According to an embodiment, the encoder 300 may, e.g., be configured to generate the bitstream such that the bitstream is a bitstream 200 according to the embodiment of FIG. 2.

In the following, particular embodiments are described.

A key idea of the disclosure is that for cases where no acoustic parameters were specified in the scene description, a ‘default acoustic environment’ can be provided in the rendering system and used in the renderer to add generic acoustic properties to the particular scene environment. In another embodiment, where no acoustic parameters were specified in the scene description for parts of the audio scene where the listener can reach, a ‘default acoustic environment’ is provided in the rendering system and used in the renderer to add generic acoustic properties to the particular scene environment.

In this way, an unnatural rendering behavior can be avoided, resulting in better subjective quality of the virtual auditory environment.

The parameters of the default acoustic environment can include a multitude of aspects that characterize the typical acoustic behavior of acoustic spaces, include (but not limited to)
Parameters for characterizing early reflections (e.g. an ‘echo’ delay and/or density)
Parameters for late reverberation like pre-delay time, reverberation time RT60, reverberation amplitude
Parameters to change the timbre of the sound sources to simulate the effect of air absorption and wind turbulences (EQ, low-pass filter)
Parameters that describe the spatial region (the acoustical horizon) in which sound sources must be located to be processed using the default acoustic environment
Additional subtle sound sources like the omnipresent outdoor background noise floor (similar to the comfort noise used in voice telecommunication) can be transmitted in a bitstream to the renderer or generated in the rendering device. Also, the rendering device can be pre-equipped with waveforms (and possibly default parameters like the ID of the used background noise waveform, an indication of the background signal level, or a filtering characteristic that describe a frequency response that will be applied to the background waveform) that describe background noise signals.

In an embodiment of the disclosure, the default acoustic environment may, e.g., describe an outdoor acoustic behavior.

There are different ways of making such a ‘default acoustic environment’ available.

In a basic renderer system, the parameters of the default acoustic environment are built into the renderer and can be activated automatically when no other acoustic environment data is available.

In a more comprehensive scenario that includes VR/AR audio scene encoding and a bitstream that can be stored and/or transmitted to a decoder/renderer over a network, the encoder can signal the use of the default acoustic environment through a metadata bitstream to the renderer. There are multiple ways of doing this:

The transmission of a default acoustic environment can be indicated in the bitstream by a distinct code or in any other way differing from the signaling of a regular scene-specific acoustic environment.

In an embodiment of the disclosure, the default acoustic environment data is signaled almost identically to the other acoustic environments (i.e. acoustic environments defined by the scene provider). Specifically, the bitstream elements for signaling acoustic environments include fields for reverberation parameters (as described previously) and other parameters (e.g. additional background sound) plus a description of the geometric region within which the acoustic environment is valid/defined. Typically, this region can be defined as either a geometric primitive (e.g. a sphere, or a box) or as a mesh consisting of a multitude of faces. However, while signaling of regular acoustic environments includes such a field for describing the geometry of the acoustic environment's region, the default acoustic environment is signaled by transmitting a special reserved code instead.

As an example a ‘Null’ (null pointer) can be transmitted instead of the specification of the geometric region of a regular acoustic environment).

Furthermore, the renderer can include built-in pre-installed data for one or several pre-defined default acoustic environments (which are available for use by the scene authors).

In this case, the encoder can signal which of these default acoustic environment settings should be used by a specific bitstream field. The selection possibility of these default settings can be made available and selected during scene authoring/encoding.

In the following, particular aspects of some of the embodiments are described.

At first, renderer aspects of particular embodiments, possibly controlled by the bitstream element are described.

For example, in a particular embodiment, an audio renderer is provided that is equipped to render the auditory impression of virtual acoustic environments including the aspects of
(late) reverberation-possibly including parameters like pre-delay time, reverberation time RT60, reverberation amplitude
optionally: early reflections
optionally: Additional subtle sound sources (like outdoor background noise floor).

The renderer may, e.g., be characterized by the capability of recognizing and rendering settings for a default acoustic environment which is applied in the scene regions where no other acoustic environment has been specified.

In an embodiment, this default acoustic environment may, for example, characterize the acoustic characteristics of an outdoor situation.

In a further embodiment, the signaling of the default acoustic environment may, for example, include a special code that is sent instead of transmitting the geometric region within which the acoustic environment is valid/defined. As an example, a ‘Null’ (null pointer) can be transmitted to the renderer instead of the specification of the geometric region of a regular acoustic environment.

Furthermore, in a particular embodiment, the renderer may, e.g., be configured such that the renderer can include built-in pre-installed data for one or several pre-defined default acoustic environments. In this case, the renderer accepts an input bitstream field which of these default acoustic environment settings should be used.

Furthermore, in a particular embodiment, the rendering device may, e.g., be configured such that the rendering device can include built-in pre-installed waveforms (and possibly default parameters like the ID of the used background noise waveform, an indication of the background signal level, or a filtering characteristic that describe a frequency response that will be applied to the background waveform) that describe background noise signals. This default parameters can be overridden with values transmitted in a bitstream.

Now, bitstream aspects of particular embodiments are described.

For example, in a particular embodiment, a bitstream is provided that may, for example, include the following information:

Information about a default acoustic environment, signaled with a special code that is sent instead of transmitting the geometric region within which the acoustic environment is valid/defined. As an example, a ‘Null’ (null pointer) can be transmitted to the renderer instead of the specification of the geometric region of a regular acoustic environment.

Specifically, the acoustic environment may, e.g., include data on
Reverb
Early reflections
Background sound

Rendering parameters for background sound may, for example, include an ID of the used background noise waveform, an indication of the background signal level, or a filtering characteristic that describe a frequency response that will be applied to the background waveform.

According to an embodiment, a set of additional parameters to be interpreted by the renderer may, for example, include:
Parameters defining conditions required to trigger all or some components of the default acoustic environment
Exclusive modifiers of isolated aspects, i.e. Gain, Distance weighting, Time delay, Occlusion weighting, Speed weighting, Spatial source saturation weighting

According to a particular embodiment, a bitstream field which indicates which of a number of pre-installed renderer default acoustic environment settings may, e.g., be employed.

Application fields of particular embodiments may, for example, be the field of real-time auditory 6DoF virtual environment, or may, for example, be the field of real-time virtual and augmented reality

It is to be mentioned here that all alternatives or aspects as discussed before and all aspects as defined by independent claims in the following claims can be used individually, i.e., without any other alternative or object than the contemplated alternative, object or independent claim. However, in other embodiments, two or more of the alternatives or the aspects or the independent claims can be combined with each other and, in other embodiments, all aspects, or alternatives and all independent claims can be combined to each other.

An inventively encoded or processed signal can be stored on a digital storage medium or a non-transitory storage medium or can be transmitted on a transmission medium such as a wireless transmission medium or a wired transmission medium such as the Internet.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the disclosure can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the disclosure include a data carrier having electronically readable control signals, which are capable of cooperating with a programmable computer system, such that one of the methods described herein is performed.

Generally, embodiments of the present disclosure can be implemented as a computer program product with a program code, the program code being operative for performing one of the methods when the computer program product runs on a computer. The program code may for example be stored on a machine readable carrier.

Other embodiments include the computer program for performing one of the methods described herein, stored on a machine readable carrier or a non-transitory storage medium.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) including, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment includes a processing means, for example a computer, or a programmable logic device, configured to or adapted to perform one of the methods described herein.

A further embodiment includes a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this disclosure has been described in terms of several embodiments, there are alterations, permutations, and equivalents which fall within the scope of this disclosure. It should also be noted that there are many alternative ways of implementing the methods and compositions of the present disclosure. It is therefore intended that the following appended claims be interpreted as including all such alterations, permutations and equivalents as fall within the true spirit and scope of the present disclosure.

1. An apparatus for rendering a virtual audio scene, comprising:
an input interface configured for receiving audio information, wherein the audio information comprises audio information for the virtual audio scene; and
a renderer configured for generating, depending on the audio information for the virtual audio scene, one or more audio output channels for reproducing the virtual audio scene,
wherein, upon determining that information on a current acoustic environment of the virtual audio scene is unavailable for the renderer, the renderer is configured to generate the one or more audio output channels for reproducing the virtual audio scene depending on information on a default acoustic environment.

2. The apparatus according to claim 1,
wherein, upon determining that the information on the current acoustic environment of the virtual audio scene is available for the renderer, the renderer is configured to generate the one or more audio output channels for reproducing of the virtual audio scene depending on the information on the current acoustic environment of the virtual audio scene.

3. The apparatus according to claim 2,
wherein the input interface is configured to receive a bitstream comprising the audio information,
wherein, upon determining that the bitstream comprises information on the current acoustic environment of the virtual audio scene, the current acoustic environment of the virtual audio scene is available for the renderer, and the renderer is configured to generate the one or more audio output channels for reproducing the virtual audio scene depending on the information on the current acoustic environment of the virtual audio scene being comprised by the bitstream,
wherein, upon determining that the bitstream fails to comprise the information on the current acoustic environment of the virtual audio scene, the current acoustic environment of the virtual audio scene is unavailable for the renderer, and the renderer is configured to generate the one or more audio output channels for reproducing the virtual audio scene depending on the information on the default acoustic environment.

4. The apparatus according to claim 3,
wherein the bitstream comprises information on the default acoustic environment.

5. The apparatus according to claim 3,
wherein the apparatus further comprises a memory having stored thereon predefined information, wherein the predefined information comprises the default acoustic environment.

6. The apparatus according to claim 1,
wherein the default acoustic environment represents an outdoor acoustic environment.

7. The apparatus according to claim 1,
wherein, for each region of a plurality of regions of the virtual audio scene, for which information on a current acoustic environment for said region is available for the renderer, the renderer is configured to generate the one or more audio output channels for reproducing the virtual audio scene using the information on the current acoustic environment for said region, upon determining that a listener is in said region, and
wherein, for each region of the plurality of regions of the virtual audio scene, for which information on the current acoustic environment for said region is unavailable for the renderer, the renderer is configured to use the information on the default acoustic environment as information on an acoustic environment for said region to generate the one or more audio output channels for reproducing the virtual audio scene, upon determining that the listener is in said region.

8. The apparatus according to claim 7,
wherein, upon determining that at least one region of the plurality of regions of the virtual audio scene, information on the current acoustic environment for said at least one region is available for the renderer, and, upon determining that the listener is in one of said at least one regions, the renderer is configured to use the information on the current acoustic environment for said region to generate the one or more audio output channels for reproducing the virtual audio scene, and
wherein, upon determining that at least two regions of the plurality of regions of the virtual audio scene, information on the current acoustic environment for said at least two regions is not available for the renderer, and, upon determining that the listener is in one of said at least two regions, the renderer is configured to use the information on the default acoustic environment as the information on the acoustic environment for said region to generate the one or more audio output channels for reproducing the virtual audio scene.

9. The apparatus according to claim 7,
wherein the receiving interface is configured to receive indication data indicating those of the plurality of regions of the virtual audio scene for which the current acoustic environment is valid, or indicating those of the plurality of regions of the virtual audio scene for which the current acoustic environment is invalid,
wherein, for each region of the plurality of regions of the virtual audio scene, upon determining that the current acoustic environment is valid, the renderer is configured to generate the one or more audio output channels for reproducing the virtual audio scene using the information on the current acoustic environment for said region, upon determining that the listener is in said region, and
wherein, for each region of the plurality of regions of the virtual audio scene, upon determining that the current acoustic environment is invalid, the renderer is configured to use the information on the default acoustic environment as the information on the acoustic environment for said region to generate the one or more audio output channels for reproducing the virtual audio scene, upon determining that the listener is in said region.

10. The apparatus according to claim 7,
wherein the information on the default acoustic environment comprises one or more reverberation parameters which comprise information on one or more properties of reverberation in the default acoustic environment,
wherein, upon determining that the information on the current acoustic environment for a region of the plurality of regions of the virtual audio scene is available for the renderer, the renderer is configured to generate the one or more audio output channels for reproducing the virtual audio scene depending on the one or more reverberation parameters of the current acoustic environment for said region, upon determining that the listener is in said region, and
wherein, upon determining that the information on the current acoustic environment for said region is unavailable for the renderer, the renderer is configured to generate the one or more audio output channels for reproducing the virtual audio scene depending on the one or more reverberation parameters of the information on the default acoustic environment, upon determining that the listener is in said region.

11. The apparatus according to claim 10,
wherein the one or more reverberation parameters of the information on the default acoustic environment comprise information on one or more of a pre-delay time, a reverberation time, and a reverberation amplitude.

12. The apparatus according to claim 7,
wherein the information on the default acoustic environment comprises one or more early reflection parameters which comprise information on one or more properties of early reflections in the default acoustic environment,
wherein, upon determining that the information on the current acoustic environment for a region of the plurality of regions of the virtual audio scene is available for the renderer, the renderer is configured to generate the one or more audio output channels for reproducing the virtual audio scene depending on the one or more early reflection parameters of the current acoustic environment for said region, upon determining that the listener is in said region, and
wherein, upon determining that the information on the current acoustic environment for said region is unavailable for the renderer, the renderer is configured to generate the one or more audio output channels for reproducing the virtual audio scene depending on the one or more early reflection parameters of the information on the default acoustic environment, upon determining that the listener is in said region.

13. The apparatus according to claim 7,
wherein the information on the default acoustic environment comprises one or more background parameters which comprise information one or more properties of background sound in the default acoustic environment,
wherein, upon determining that the information on the current acoustic environment for a region of the plurality of regions of the virtual audio scene is available for the renderer, the renderer is configured to generate the one or more audio output channels for reproducing the virtual audio scene depending on the one or more background parameters of the information on the current acoustic environment for said region, upon determining that the listener is in said region,
wherein, upon determining that the information on the current acoustic environment for said region is not available for the renderer, the renderer is configured to generate the one or more audio output channels for reproducing the virtual audio scene depending on the one or more background parameters of the information on the default acoustic environment, upon determining that the listener is in said region.

14. The apparatus according to claim 13,
wherein the one or more background parameters of the information on the default acoustic environment comprise one or more rendering parameters for the background sound, wherein said rendering parameters comprise information on one or more of a background sound waveform, an identifier of the background sound waveform, a background signal level, and a filtering characteristic that indicates a frequency response that is to be applied on the background sound waveform.

15. The apparatus according to claim 7,
wherein the information on the default acoustic environment comprises one or more default acoustic environment steering parameters for steering a usage of the default acoustic environment by the renderer,
wherein, upon determining that the information on the current acoustic environment for a region of the plurality of regions of the virtual audio scene is available for the renderer, the renderer is configured to generate the one or more audio output channels for reproducing the virtual audio scene using, depending on the default acoustic environment steering parameters, the information on the current acoustic environment for said region, upon determining that the listener is in said region, and
wherein, upon determining that the information on the current acoustic environment for said region is not available for the renderer, the renderer is configured to generate the one or more audio output channels for reproducing the virtual audio scene using, depending on the default acoustic environment steering parameters, the information on the default acoustic environment, upon determining that the listener is in said region.

16. The apparatus according to claim 7,
wherein the default acoustic environment comprises one or more triggering conditions required to trigger one or more or all of the parameters or components of the default acoustic environment,
wherein, upon determining that the information on the current acoustic environment for a region of the plurality of regions of the virtual audio scene is unavailable for the renderer, the renderer is configured to generate the one or more audio output channels for reproducing the virtual audio scene depending on the information on the default acoustic environment by triggering those parameters or components of the default acoustic environments whose at least one triggering condition of the one or more triggering conditions are fulfilled.

17. The apparatus according to claim 7,
wherein the information on the default acoustic environment comprises one or more modification parameters for modifying at least one of a gain, a distance weighting, a time delay, an occlusion weighting, a speed weighting, or a spatial source saturation weighting, and
wherein the renderer is configured to generate the one or more audio output channels for reproducing the virtual audio scene depending on the one or more modification parameters.

18. The apparatus according to claim 7,
wherein the virtual audio scene depends on a recording of a real audio scene under a real acoustic environment.

19. The apparatus according to claim 18,
wherein, for each region of the plurality of regions of the virtual audio scene, for which information on a current acoustic environment for said region is available for the renderer, the current acoustic environment for said region represents the real acoustic environment of a real region of the real audio scene corresponding to said region of the virtual audio scene,
wherein, for each region of the plurality of regions of the virtual audio scene, for which information on the current acoustic environment for said region is unavailable for the renderer, the default acoustic environment fails to represent the real acoustic environment of the real region of the real audio scene corresponding to said region of the virtual audio scene.

20. The apparatus according to claim 7,
wherein the virtual audio scene is associated with a virtual visual scene, wherein the virtual visual scene depicts to the listener of the virtual audio scene a virtual visual room.

21. The apparatus according to claim 20,
wherein, for each region of the plurality of regions of the virtual audio scene, for which information on a current acoustic environment for said region is available for the renderer, the current acoustic environment for said region depends on virtual acoustic properties of a region of the virtual visual room, which corresponds to said region of the virtual audio scene,
wherein, for each region of the plurality of regions of the virtual audio scene, for which information on the current acoustic environment for said region is unavailable for the renderer, the default acoustic environment fails to depend on virtual acoustic properties of a region of the virtual visual room, which corresponds to said region of the virtual audio scene.

22. The apparatus according to claim 7,
wherein a location of the listener in the virtual audio scene depends on a physical location of the listener in the real world.

23. The apparatus according to claim 22,
wherein the virtual audio scene is associated with a virtual visual presentation of an augmented reality application, wherein the virtual visual presentation of the augmented reality application depends on a real region of a physical environment in the real world, where the listener of the virtual audio scene is located.

24. The apparatus according to claim 23,
wherein, for each region of the plurality of regions of the virtual audio scene, for which information on a current acoustic environment for said region is available for the renderer, the current acoustic environment for said region depends on real acoustic properties of a region of the physical environment the real world, which corresponds to said region of the virtual audio scene,
wherein, for each region of the plurality of regions of the virtual audio scene, for which information on the current acoustic environment for said region is unavailable for the renderer, the default acoustic environment is independent from acoustic properties of a region the physical environment of the real world, which corresponds to said region of the virtual audio scene.

25. The apparatus according to claim 24,
wherein, upon determining that the real region in the real world, where the listener is located, corresponds to a region of the virtual audio scene, for which information on the current acoustic environment is available, the renderer is configured to generate the one or more audio output channels for reproducing the virtual audio scene depending on the current acoustic environment for said region, and
wherein, upon determining that the real region in the real world, where the listener is located, corresponds to a region of the virtual audio scene, for which information on the current acoustic environment is not available, the renderer is configured to generate the one or more audio output channels for reproducing the virtual audio scene depending on the default acoustic environment.

26. The apparatus according to claim 7,
wherein the default acoustic environment is a first default acoustic environment of two or more default acoustic environments,
wherein the input interface is configured to receive, for at least one region of the plurality of regions of the virtual audio scene, an indication indicating one of the two or more default acoustic environments as a default acoustic environment for said at least one region, and
wherein, upon determining that for the at least one region, information on the current acoustic environment for said at least one region is unavailable for the renderer, the renderer is configured to use information on the default acoustic environment for said region to generate the one or more audio output channels for reproducing the virtual audio scene, upon determining that the listener is in said region.

27. The apparatus according to claim 26,
wherein the input interface is configured to receive a bitstream comprising the audio information,
wherein, upon determining that the bitstream comprises information on the current acoustic environment of the virtual audio scene, the current acoustic environment of the virtual audio scene is made available for the renderer, and the renderer is configured to generate the one or more audio output channels for reproducing the virtual audio scene depending on the information on the current acoustic environment of the virtual audio scene being comprised by the bitstream,
wherein, if the bitstream fails to comprise the information on the current acoustic environment of the virtual audio scene, the current acoustic environment of the virtual audio scene is unavailable for the renderer, and the renderer is configured to generate the one or more audio output channels for reproducing the virtual audio scene depending on the information on the default acoustic environment, and
wherein the bitstream comprises information on the two or more default acoustic environments.

28. The apparatus according to claim 26,
wherein the apparatus comprises a memory having stored thereon predefined information, and
wherein the predefined information, being stored in the memory of the apparatus, comprises information on the two or more default acoustic environments.

29. The apparatus according to claim 26,
wherein the receiving interface is configured to receive selection information, and
wherein the renderer is configured to select said one of the two or more default acoustic environments depending on selection information, and is configured to use the information on the default acoustic environment for said at least one region to generate the one or more audio output channels for reproducing the virtual audio scene, upon determining that the listener is in said at least one region.

30. The apparatus according to claim 26,
wherein the indication indicating said one of the two or more default acoustic environments as the default acoustic environment for said at least one region comprises an identifier for each of said at least one region and comprises an identifier for said one of the two or more default acoustic environments.

31. The apparatus according to claim 1, further comprising one or more sound sources configured to emit sound in the virtual audio scene,
wherein the audio information for the virtual audio scene comprises one or more audio channels of each sound source of the one or more sound sources and a position of each of the sound source of the one or more sound sources, and
wherein the renderer is configured to generate the one or more audio output channels for reproducing the virtual audio scene depending on the one or more audio channels of each sound source of the one or more sound sources, depending on the position of each of the sound source of the one or more sound sources and depending on a position of a listener in the virtual audio scene.

32. The apparatus according to claim 31,
wherein the position of the sound source and the position of the listener are defined for three dimensions or two dimensions.

33. The apparatus according to claim 31,
wherein the position of the sound source is defined for three dimensions,
wherein the listener position and orientation are defined for six-degrees-of-freedom, such that the position of the listener are defined for three dimensions, and the orientation of a head of the listener is defined using three rotation angles, and
wherein the renderer is configured to generate the one or more audio output channels for reproducing the virtual audio scene further depending on the orientation of the head of the listener in the virtual audio scene.

34. The apparatus according to claim 1, further comprising a sound scene generator,
wherein the sound scene generator is configured to reproduce the virtual audio scene of a virtual reality application or
of an augmented reality application.

35. The apparatus according to claim 1, further comprising one or more sound sources configured to emit sound in the virtual audio scene,
wherein the one or more audio channels of at least one sound source of the one or more sound sources are represented in an Ambisonics Domain,
wherein the renderer is configured to generate the one or more audio output channels for reproducing the virtual audio scene depending on the one or more audio channels of said at least one sound source of the one or more sound sources being represented in the Ambisonics Domain.

36. The apparatus according to claim 1,
wherein the renderer comprises a binauralizer configured to generate two audio output channels for reproducing the virtual audio scene.

37. The apparatus according to claim 1,
wherein, upon determining that one or more, though without all of a plurality of parameters of the current acoustic environment are available for the renderer, the renderer is configured to generate the one or more audio output channels for reproducing the virtual audio scene depending on those of a plurality of parameters of the information on the default acoustic environment, which the current acoustic environment within the bitstream is provided without.

38. The apparatus according to claim 1,
wherein, upon determining that the information on the current acoustic environment of the virtual audio scene is available for the renderer, the renderer is configured to generate the one or more audio output channels for reproducing the virtual audio scene using, depending on an availability of resources of the renderer to render acoustic properties, the information on the current acoustic environment of the virtual audio scene, or the information on the default acoustic environment.

39. A bitstream, comprising,
an encoding of one or more audio channels of each sound source of one or more sound sources emitting sound into a virtual audio scene, and
a plurality of data fields comprising information on a default acoustic environment.

40. The bitstream according to claim 39,
wherein the information on the default acoustic environment within the bitstream comprises one or more reverberation parameters of the default acoustic environment which comprise information on one or more properties of reverberation in the default acoustic environment.

41. The bitstream according to claim 40,
wherein the one or more reverberation parameters of the information on the default acoustic environment comprise information on one or more of a pre-delay time, a reverberation time, and a reverberation amplitude.

42. The bitstream according to claim 39,
wherein the information on the default acoustic environment within the bitstream comprises one or more early reflection parameters which comprise information on one or more properties of early reflections in the default acoustic environment.

43. The bitstream according to claim 39,
wherein the information on the default acoustic environment within the bitstream comprises one or more background parameters which comprise information one or more properties of background sound in the default acoustic environment.

44. The bitstream according to claim 43,
wherein the one or more background parameters of the information on the default acoustic environment within the bitstream comprise one or more rendering parameters for the background sound, wherein said rendering parameters comprise information on one or more of a background sound waveform, an identifier of the background sound waveform, a background signal level, and a filtering characteristic that indicates a frequency response that is to be applied on the background sound waveform.

45. The bitstream according to claim 39,
wherein the bitstream comprises one or more default acoustic environment steering parameters for steering a usage of the default acoustic environment by a renderer.

46. The bitstream according to claim 39,
wherein the default acoustic environment comprises one or more triggering conditions required to trigger one or more or all of the parameters or components of the default acoustic environment.

47. The bitstream according to claim 39,
wherein the bitstream comprises one or more modification parameters for modifying at least one of a gain, a distance weighting, a time delay, an occlusion weighting, a speed weighting, and a spatial source saturation weighting.

48. The bitstream according to claim 39,
wherein the information on the default acoustic environment comprises a first information on a first default acoustic environment of two or more default acoustic environments, and
wherein the bitstream comprises information on the two or more default acoustic environments.

49. The bitstream according to claim 48,
wherein the bitstream comprises selection information for selecting one of the two or more default acoustic environments.

50. The bitstream according to claim 48,
wherein the bitstream specifies, for at least one region of plurality of regions, one of the two or more default acoustic environments as a default acoustic environment for said at least one region.

51. The bitstream according to claim 50,
wherein the bitstream comprises an identifier for each of said at least one region, or an identifier for said one of the two or more default acoustic environments to indicate the default acoustic environment for said at least one region.

52. The bitstream according to claim 39,
wherein the bitstream further comprises information on a current acoustic environment of the virtual audio scene.

53. The bitstream according to claim 52,
wherein the bitstream comprises indication data indicating at least one of plurality of regions for which the current acoustic environment is valid, or indicating one or more of the plurality of regions for which the current acoustic environment is not valid.

54. The bitstream according to claim 39,
wherein the bitstream further comprises information on a current acoustic environment for at least one region of plurality of regions of the virtual audio scene.

55. The apparatus according to claim 1, further comprising a bitstream,
wherein the bitstream comprises information on the default acoustic environment,
wherein the bitstream received by the receiving interface comprises:
an encoding of one or more audio channels of each sound source of one or more sound sources emitting sound into a virtual audio scene, and
a plurality of data fields comprising information on a default acoustic environment,
wherein, upon determining that the bitstream is without information on the current acoustic environment of the virtual audio scene, the renderer is configured to generate the one or more audio output channels for reproducing the virtual audio scene depending on the information on the default acoustic environment being comprised by the bitstream, such that generating the one or more audio output channels depends on one or more of the following:
one or more reverberation parameters of the default acoustic environment which comprise information on one or more properties of reverberation in the default acoustic environment and/or information on one or more of a pre-delay time, a reverberation time, and a reverberation amplitude,
one or more early reflection parameters which comprise information on one or more properties of early reflections in the default acoustic environment,
one or more background parameters which comprise information one or more properties of background sound in the default acoustic environment, or one or more rendering parameters for the background sound, wherein said rendering parameters comprise information on one or more of a background sound waveform, an identifier of the background sound waveform, a background signal level, and a filtering characteristic that indicates a frequency response that is to be applied on the background sound waveform,
one or more default acoustic environment steering parameters for steering a usage of the default acoustic environment by the renderer, or
one or more triggering conditions required to trigger one or more or all of the parameters or components of the default acoustic environment.

56. An encoder, configured for generating a bitstream,
wherein the encoder is configured to generate the bitstream such that the bitstream comprises an encoding of one or more audio channels of each sound source of one or more sound sources emitting sound into a virtual audio scene, and
wherein the encoder is configured to generate the bitstream such that the bitstream comprises a plurality of data fields comprising information on a default acoustic environment.

57. The encoder according to claim 56,
wherein the encoder is configured to generate the bitstream such that the bitstream comprises:
an encoding of one or more audio channels of each sound source of one or more sound sources emitting sound into a virtual audio scene, and
a plurality of data fields comprising information on a default acoustic environment.

58. A method for rendering a virtual audio scene, the method comprises:
receiving audio information, wherein the audio information comprises audio information for the virtual audio scene; and
generating, depending on the audio information for the virtual audio scene, one or more audio output channels for reproducing the virtual audio scene,
wherein, upon determining that information on a current acoustic environment of the virtual audio scene is unavailable, generating the one or more audio output channels for reproducing the virtual audio scene is conducted depending on information on a default acoustic environment.

59. A method for generating a bitstream,
wherein generating the bitstream is conducted such that the bitstream comprises an encoding of one or more audio channels of each sound source of one or more sound sources emitting sound into a virtual audio scene, and
wherein generating the bitstream is conducted such that the bitstream such that the bitstream comprises a plurality of data fields comprising information on a default acoustic environment.

60. A non-transitory computer-readable medium comprising a computer program for implementing the method of claim 58 upon being executed on a computer or signal processor.

61. A non-transitory computer-readable medium comprising a computer program for implementing the method of claim 59 upon being executed on a computer or signal processor.
